(19) United States
(12) Patent Application Publication
(10) Pub. No.: US 2011/0173033 A1
(43) Pub. Date: Jul. 14, 2011

(54) Systems and methods for utilizing an enterprise map to determine affected entities

(75) Inventors: Deidre Paknad, Palo Alto, CA (US); Puttappaiah Muniyappa, Cupertino, CA (US)

(73) Assignee: PSS Systems, Inc.

(21) Appl. No.: 11/505,537

(22) Filed: Aug. 16, 2006

(51) Int. Cl. G06Q 10/00

(52) U.S. Cl. 705/7.11

(57) ABSTRACT

Systems and methods for utilizing an enterprise map to determine affected entities are provided. In exemplary embodiments, the entities comprise people and systems in, or associated with, an enterprise. The method comprises receiving at least one scope parameter. Utilizing the at least one scope parameter and relationships in the enterprise map, affected people and systems are determined. Workflow may automatically be generated based on a list of the affected people and systems.

### CROSS REFERENCE TO RELATED APPLICATION

The present application is related to U.S. patent application Ser. No. 11/______, filed Aug. 16, 2006 and entitled “Systems and Methods for Utilizing Organization-Specific Classification Codes,” which is herein incorporated by reference.

### BACKGROUND OF THE INVENTION

1. Field of the Invention

Embodiments of the present invention relate generally to data management and more particularly to utilizing a data map within an enterprise system.

2. Description of Related Art

Conventionally, information retrieval is accomplished by searches using keywords, people, and dates. If a specific set of information is sought, very specific parameters may need to be input into a system that maintains the information in order to locate the set of information.

For litigation purposes, data and evidence within a company is required to be preserved in anticipation of, or during, litigation. Traditionally, the company will identify affected employees and systems likely to be associated with the litigation related data and evidence. In large companies, however, the identification of affected employees and systems is often complex. However, it is vital that the company quickly determines the affected employees and systems in order to notify the employees to preserve the data and evidence.

Traditional records management systems allow a record administrator to select a class or classes of records and a date range solely for identifying data stored within the particular records management system. Disadvantageously, these records management systems do not allow selection of employees, other repositories, or systems. The identification of a class or classes of records only captures data and evidence for the identified classes of records, and does not take into consideration the people associated with the records.

Conventionally, individuals manually determine the affected and involved people in a legal matter. There is typically no purpose-built application to perform this determination. Instead, it is usually a manual process using interviews, research through employee directories and organizational charts, and so forth.

Therefore, there is a need for systems and methods that quickly and accurately determine affected people and systems associated with a matter.

### SUMMARY OF THE INVENTION

Embodiments of the present invention provide systems and methods for utilizing an enterprise map to determine affected entities (e.g., people and systems). The exemplary method comprises receiving at least one scope parameter from a user. The at least one scope parameter may comprise information type, organization specific classification codes, repositories, stewards of the repositories, or organizations.

Utilizing the at least one scope parameter and relationships in the enterprise map, affected people and systems are determined. In some embodiments, the at least one scope parameter may be used to derive at least one further scope parameter. The scope parameters are utilized to review the relationships in the map until the affected people and systems are identified.

Workflow may automatically be generated based on a list of the affected people and systems. The workflow may comprise sending notifications to the affected people to preserve documents and to produce documents. In some embodiments, the workflow may comprise interviews with, or data collection from, the affected people.

### BRIEF DESCRIPTION OF THE DRAWINGS

FIG. 1 is an exemplary environment in which embodiments of the present invention may be practiced;

FIG. 2 is a block diagram of an exemplary map engine;

FIG. 3 is a schematic diagram of exemplary relationships between objects within a map of an enterprise;

FIG. 4 is a block diagram of an exemplary litigation management engine;

FIG. 5 is a flowchart of a method for utilizing the map in order to determine affected people and systems;

FIG. 6 is a flowchart of a method for determining the affected people and systems;

FIG. 7a-FIG. 7c are exemplary screen shots of a graphical user interface (GUI) for election of scope parameters;

FIG. 8 is an exemplary screen shot of a GUI illustrating a derived list of affected people; and

FIG. 9 is an exemplary screen shot of a GUI illustrating a derived list of affected systems.

### DETAILED DESCRIPTION OF EXEMPLARY EMBODIMENTS

Embodiments of the present invention provide an exemplary system and method for utilizing an enterprise map in order to determine affected entities. These entities may comprise people and systems in, or associated with, an enterprise. The enterprise map comprises relationships between various objects that represent the data comprising the enterprise. Based on these relationships in the enterprise map, affected people and systems may be rapidly, automatically, and systematically determined. Affected people may comprise individual employees, record coordinators and administrators responsible for a class of information or associated with an information repository, and system administrators and IT staff responsible for the information repositories along with names, contact information, e-mail addresses, organizations, and location of the employees. Affected systems may comprise the repositories storing the data of interest. In some embodiments, the affected people may have physical possession of the data of interest.

Based on a derived list of affected people and systems, workflow may be automatically generated, and in some embodiments, automatically performed. The workflow may comprise notifying relevant individuals of their duty to preserve any evidence in their possession, and determining which people need to be interviewed in the course of a matter. Workflow may also comprise identifying what protocols should be used to collect data from affected systems, and flagging any relevant data (e.g., records classification) and retention schedules. Workflow may further comprise tasking assignments and tracking for interviews. Appropriate record coordinators or administrators for these affected systems are also alerted to preservation requirements.

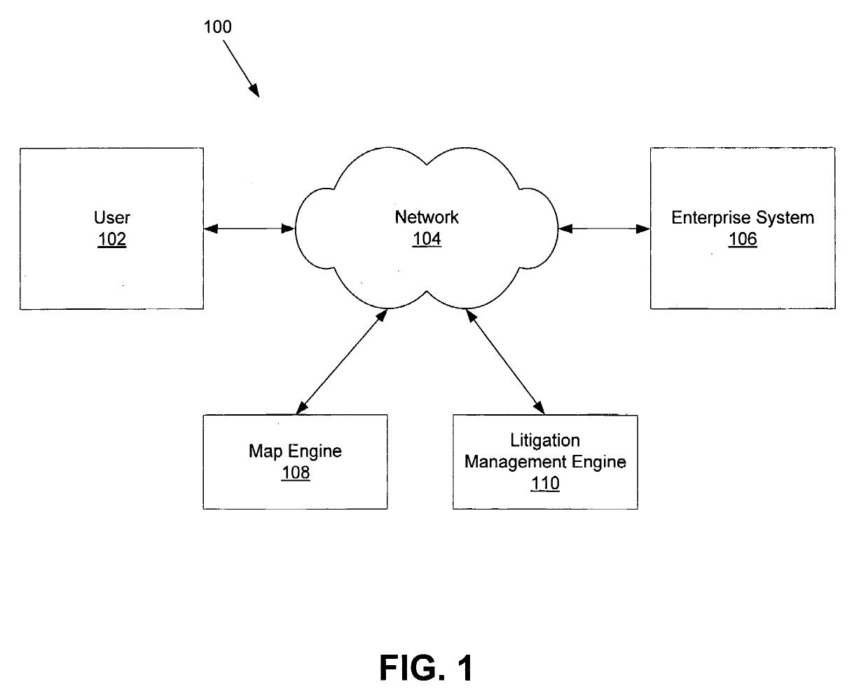

FIG. 1 shows an exemplary environment 100 in which embodiments of the present invention may be practiced. The environment 100 comprises at least one user 102 coupled via a network 104 to an enterprise system 106. In exemplary embodiments, the network 104 may be a local area network, a wide area network, peer-to-peer network, or the Internet. Alternatively, the user 102 may be coupled directly to the enterprise system 106 or access the enterprise system 106 from within the enterprise system 106. In some embodiments, more than one network and/or more than one type of network may be utilized to allow the components of the environment 100 to communicate with each other.

Any number of users 102 may be present in the environment 100. The user 102 may be an individual accessing the enterprise system 106 in order to determine affected people and systems associated with a matter. In exemplary embodiments, the matter is related to a litigation matter. In these embodiments, the user 102 may comprise an attorney or legal staff associated with the litigation matter. However, in alternative embodiments, the matter may be related to any matter of interest to the user 102 (e.g., tax, regulatory, internal investigation, policy-related examination/investigation, audit).

In some embodiments, a computing device associated with the user 102 may comprise an optional business application (not shown) that performs actions related to the map. For example, the business application may interact with a litigation management engine 110 to derive a list of people and systems affected by a litigation matter. In an alternative embodiment, the business application may comprise the litigation management engine 110 and/or the map engine 108. In other embodiments, the business application interacts with a user interface module in the map engine 108 and/or the litigation management engine 110, as will be discussed below.

The exemplary enterprise system 106 may comprise any number of servers, client devices, and repositories comprising data. The enterprise system 106 may further comprise a totality of IT, storage and information management systems in an enterprise, including those internally managed, outsourced, etc. The data may comprise documents, files, audio and video media, e-mail communication, and any other information which may be stored in repositories. Repositories may comprise both physical and digital storage media including warehouses, filing cabinets, hard drives, and other digital media storage devices. The repositories may be located anywhere in an enterprise (e.g., in different jurisdictions).

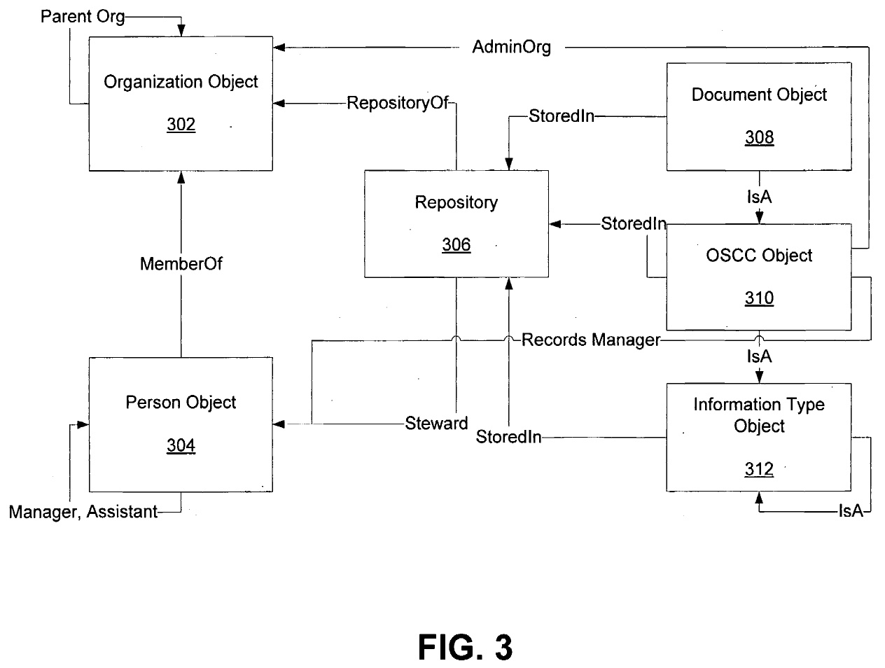

The exemplary map engine 108 maintains a map comprising a structure that represents people, repositories, organizations, and documents via relationships. The map engine 108 utilizes information types, organizations, storage locations, people, and other objects and their relationships, as will be discussed in more detail in connection with FIG. 3, to provide an overall map structure that is used to derive relationships between people, repositories, and organizations. As a result, the user 102 can use the map to determine affected people and systems in the enterprise system 106. While the map engine 108 is shown coupled to the enterprise system 106, the map engine 108 may be comprised within the enterprise system 106.

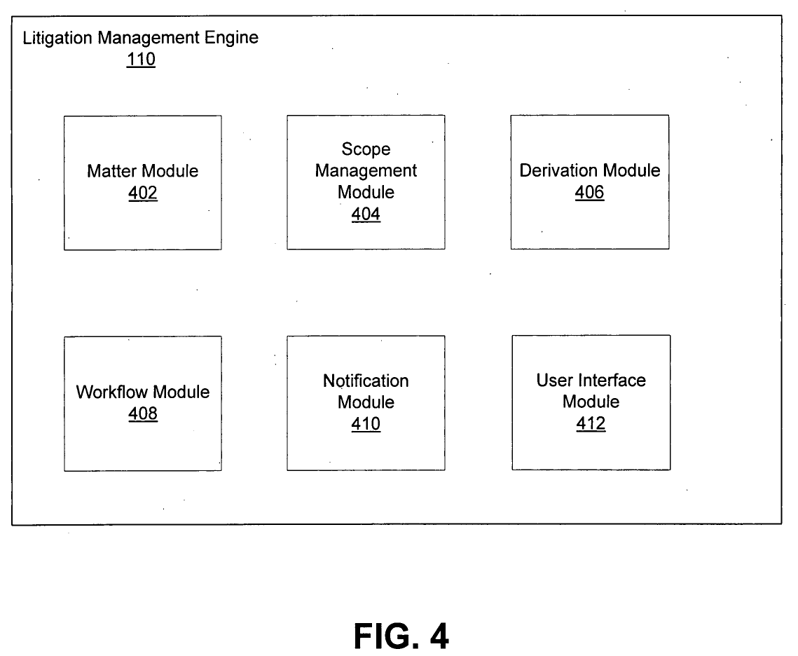

The litigation management engine 110 is configured to determine affected people and systems associated with a litigation matter. The exemplary litigation management engine 110 is discussed herein as being utilized to determine affected people and systems associated with a litigation matter, alternatively, the litigation management engine 110 may be utilized to determine affected people and systems for any reason. For example, the user 102 may use the litigation management engine 110 to find affected people and systems associated with a merger transaction in order to review, hold/preserve, or collect certain documents, or to interview the affected people. While the litigation management engine 110 is shown coupled to the enterprise system 106, the litigation management engine 110 may be comprised within the enterprise system 106. The litigation management engine 110 will be discussed in more detail in connection with FIG. 4.

It should be noted that the environment 100 of FIG. 1 is exemplary. Alternative embodiments may, for example, comprise the various components of the environment 100 in communication with each in a different manner. For example, a device of the user 102, the map engine 108, and the litigation management engine 110 may all, or in various combinations, be comprised within the enterprise system 106.

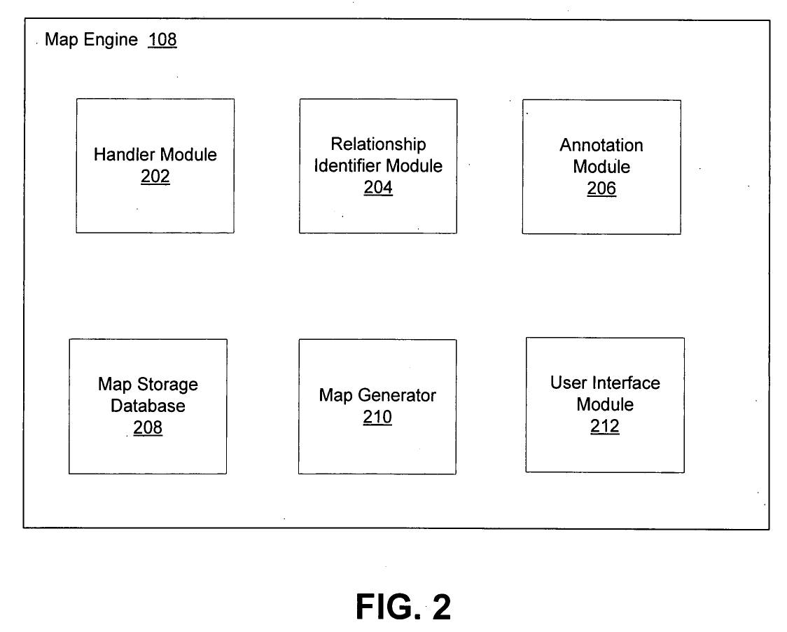

Referring now to FIG. 2, a block diagram of the exemplary map engine 108 is shown. The map engine 108 may comprise a handler module 202, a relationship identifier module 204, an optional annotation module 206, a map storage database 208, a map generator 210, and a user interface module 212. The map engine 108 may comprise other components which are not directly utilized by embodiments of the present invention. As such, these components are not discussed herein. In some embodiments, some of the components of the map engine 108 are located at a device associated with the user 102, and operate within the device of the user to provide the functionalities described below. In other embodiments, the map engine 108 is completely located at the device associated with the user 102. In yet other embodiments, the map engine 108 is completely separate from the device of the user 102, and the user 102 accesses the map engine 108 via the network 104.

The handler module 202 is configured to access data from various sources of the enterprise 106 including the repositories. In one embodiment, the handler module 202 is a crawler configured to crawl databases for updates to the data.

The relationship identifier module 204 reviews the data accessed by the handler module 202 and identifies relationships associated with the data. The relationships may be based on such objects as organization, author, and repository, for example. In exemplary embodiments, the structure of the map is based on the relationships between these objects. The various relationships will be discussed in more detail in connection with FIG. 3.

In exemplary embodiments, the annotation module 206 is provided for adding, modifying, and/or deleting annotations associated with the map and the data represented by the map. For example, the user 102 may find a set of documents related to a litigation matter. The user 102 can annotate the set of documents with a legal hold to preserve the set of documents. Any type of annotation can be provided via the annotation module 206.

The map storage database 208 stores versions of the map. As the map may change over time due to annotations, modifications, and updates, different versions of the map are maintained. Older versions of the map may be useful to provide a historical view of the map and its evolution over time. Where legal matters involve past events and the historical relationships within the enterprise system are relevant to the matter, the historical map information may be used to derive affected people or systems. In alternative embodiments, the map may be stored in a database within the enterprise system 106 or in a database located outside of the map engine 108, but coupled thereto.

The exemplary map generator 210 utilizes the objects and their relationships to create the map for the enterprise system 106. This map may then be utilized to determine affected people and systems by the litigation management engine 110.

The exemplary user interface module 212 is configured to allow the user 102 to access, review, read, query and edit the map. In some embodiments, the map may be often accessed and modified during a course of a litigation matter (e.g., a new information repository may be discovered and entered into the map by legal staff). The user interface module 212 allows for the access and modification. In some embodiments, the user interface module 212 may comprise the business application that performs actions related to the map (e.g., interact with a litigation management engine 110 to derive a list of people and systems affected by a litigation matter). In some embodiments, the user interface module 212 may be optional.

FIG. 3 illustrates a schematic diagram of exemplary relationships of primary objects in the map used for supporting derivation of a list of affected people and/or systems. Exemplary embodiments of the present invention take advantage of the fact that people have certain types of relationships to organizations, and information repositories have a responsible person/people (i.e., stewards) and associated disposal and retention policies. As discussed herein, the map establishes exemplary relationships between the objects as shown.

In exemplary embodiments, each document is classified with an organization specific classification code (OSCC). The OSCC identifies both an information type and an organization within a single classification code. Any number of organizations may comprise the enterprise system 106. For example, ADM-212 may be an OSCC only utilized by a New York office (i.e., organization) of an investment bank to classify administrative internal memos (i.e., information type).

Each OSCC may also have a policy associated with the OSCC. All documents having the particular OSCC are subject to the same policy. These policies may comprise a custodian (i.e., storage location), a record manager, and other important information which is pertinent to all documents sharing the OSCC. In some embodiments, the policy may also comprise information such as a retention period, security and access, and legal holds.

Because the OSCC provides an intrinsic relationship between the organization, information type, and any policies associated with the OSCC, a user 102 is able to find relevant information more easily and quickly. Based on people, custodians, organizations, or information types known to be relevant to a legal matter, for example, a subset of all enterprise OSCCs can be derived that are relevant to the legal matter. More specifically, the user 102 can search for a specific OSCC and identify systems and people associated with the legal matter. In further embodiments, the user 102 may be able search for and identify exact data and/or evidence that are classified with a given OSCC.

An organization object 302 includes information about the organization or other groupings of people. In some embodiments, these organizations may be hierarchically organized. Any type of organization object 302 may be utilized. For example, the organization object 302 may include a name of the organization, a parent organization, persons in the organization, repositories or storage mediums utilized by the organization, geography associated with the organization, organization locations, accounting codes, and so forth. One or more organizations may be represented by the organization object 302 and the one or more organizations may be designated according to a hierarchical structure, such as a parent organization.

A person object 304 represents an individual with a role within the organization. For example, the person object 304 may include an employee in the organization. The person object 304 may be associated with one or more items of information by a name, contact information, role in the organization, relationship with other persons 304, organizational affiliations, repository affiliations, responsibilities, job title, and so forth. The person object 304 may be related to the organization object 302 by virtue of a “MemberOf” relationship, which indicates that each person is a member of one or more organizations. For example if a person works at a NY office of an investment bank, the user (i.e., person object 304) is affiliated with the NY office (i.e., organization object 302).

A repository object 306 represents storage locations. The repository object 306 may include any electronic or non-electronic information repositories, such as a warehouse, a file server, or any other storage mediums. The repository object 306 may include or be related to name, system type and details, physical location, network location, access methods, stewards (i.e., the persons and the person object 304 responsible), the organizations that use the repository (e.g., organization object 302), information types stored in the repository (e.g., information type object 312), and so forth. Accordingly, the repository object 306 has a relationship with the other objects shown in FIG. 3.

A document object 308 represents information about documents, papers, text, files, metadata, and other items of data stored in a repository. The information represented by the document object 308 is thus related to the repository object 306 by being stored in the repository identified by the repository object 306.

An OSCC object 310 is associated with a classification code (i.e., the OSCC) assigned to each item of data associated with the document object 308. The OSCC object 310 may indicate information type, location in the repository 306 for the information, policy information, such as a records manager, and so forth. Once the OSCC object 310 is assigned to the item of data associated with the document object 308, the classification may be stored in a repository associated with the repository object 306. Each classification may be associated with one or more persons responsible for managing the information assigned the specific classification. Thus, the person object 304 may be related to the OSCC object 310.

In exemplary embodiments, information represented by the document object 308 is related to the OSCC object 310 by a hierarchical taxonomy of types. In other words, the information represented by the document object 308 may include OSCC data and be organized according to the OSCC data.

An information type object 312 is associated with the OSCC object 310 classification. The items of data may be organized as a hierarchical taxonomy, for example, utilizing the information type. The information type object 312 includes name, identifiers, such as record keeping codes, parent type, repository affiliations (i.e., default location for the information), organization affiliations, and so forth. An information type is a broad class of information, such as “Accounting Invoice” or “Quarterly Financial Report”, for example. A data type or document may, optionally, be associated with one or more repositories via the repository object 306 discussed herein. Accordingly, the information type object 312 is related to the repository object 306 and to the OSCC object 310. In exemplary embodiments, the OSCC is a more specific class of information that a given information type uses within a given organization.

The map engine 108 utilizes the relationships between the various objects described in FIG. 3 to generate the map. Although FIG. 3 specifies the relationship between the various objects and the various objects that may have specified relationships, any type of relationships may be identified between any of the objects.

Because various relationships between the one or more objects are known, by the relationship identifier 204 for example, the one or more items of data that may satisfy a matter may be more easily located and/or provide better and more accurate results. As discussed herein, the litigation management engine 110 can determine affected people and systems using the objects and their relationships. Although FIG. 3 shows various relationships between various objects that represent the information in the enterprise system 106, further embodiments may comprise other objects and/or relationships between the objects and still fall within the scope of various embodiments.

Referring now to FIG. 4, a detailed block diagram of the exemplary litigation management engine 108 is shown. The litigation management engine 108 comprises a matter module 402, a scope management module 404, a derivation module 406, a workflow module 408, a notification module 410, and a user interface module 412. Alternative embodiments may comprise more, less, or functionally equivalent modules. Furthermore, some of the modules of the litigation management engine 108 may be comprised in the map engine 108 or vice versa. While FIG. 4 is discussed in a context of a litigation matter and search, alternative embodiments allow for the search to be associated with non-litigation matters (e.g. internal investigations, government regulatory request for information, etc.).

In some embodiments, some of the components of the litigation management engine 110 are located at a device associated with the user 102, and operate within the device of the user to provide the functionalities described below. In other embodiments, the litigation management engine 110 is completely located at the device associated with the user 102. In yet other embodiments, the litigation management engine 110 is completely separate from the device of the user 102, and the user 102 accesses the litigation management engine 110 via the network 104.

The exemplary matter module 402 creates the litigation matter. The litigation matter identifies a legal matter for which affected people & systems are being determined (e.g., derivation of a list of affected people and/or systems). The litigation matter may also identify the attorneys and other staff that are working on the litigation matter. By identifying the relevant staff, work flow may be automatically generated for the staff upon determination of the affected people and systems. Furthermore, results of the derivation may be stored based on the litigation matter.

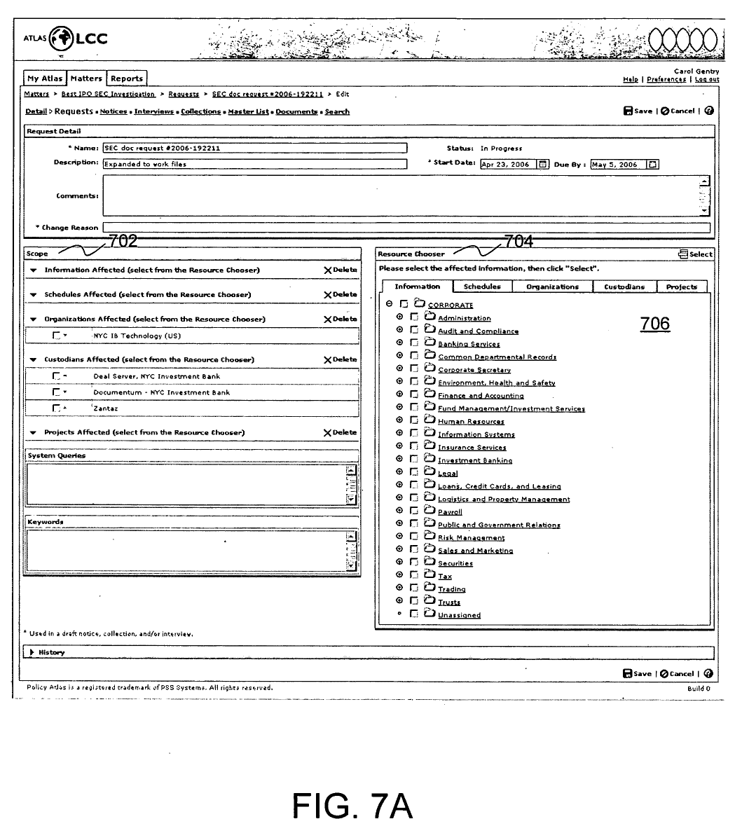

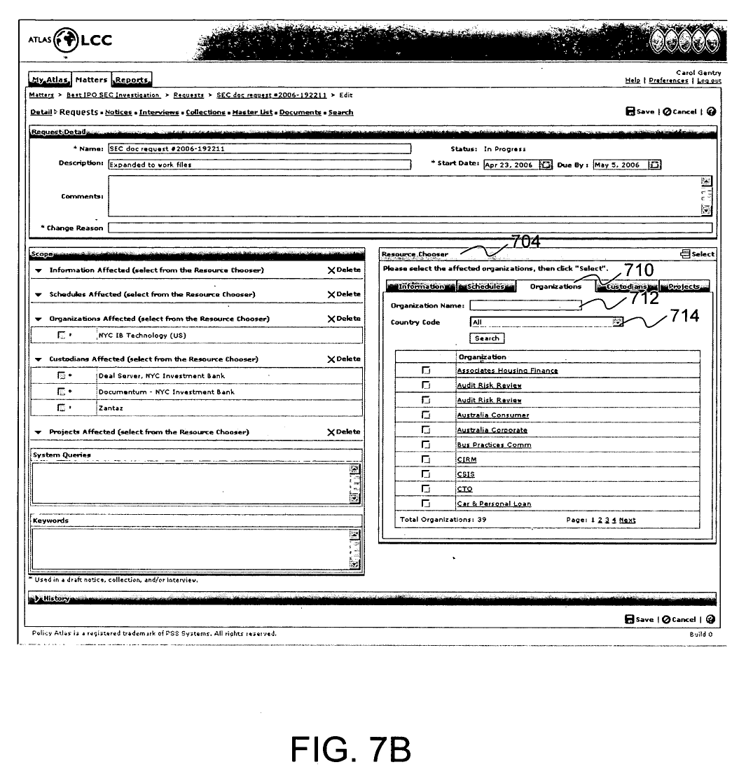

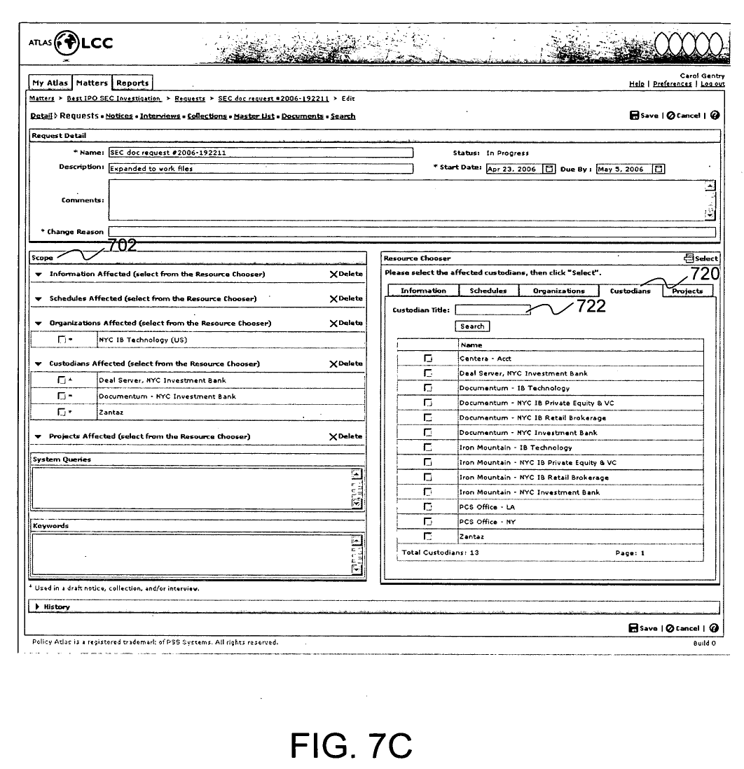

The scope management module 404 is configured to receive scope parameters from the user 102 for the derivation of key people and systems. In some embodiments, the scope management module 404 provides a graphical user interface (GUI) that allows the user 102 to provide the scope parameters. The scope parameters are one or more map objects that are known to intersect the litigation matter in some manner. For example, if the litigation matter involves a specific organization or information type, the user 102 can provide those objects as the scope parameters. The scope management GUI will be discussed in more detail in connection with FIG. 7a-FIG. 7c.

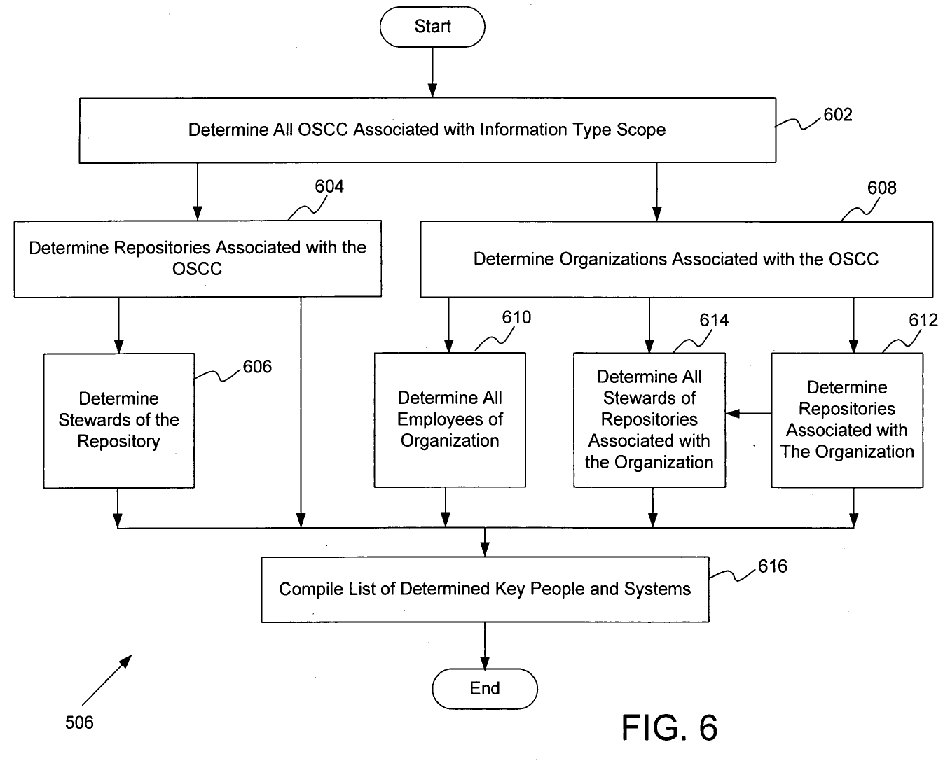

The derivation module 406 takes the scope parameters and traverses the map in order to determine the affected people and systems associated with the litigation matter based on relationships identified within the map. In exemplary embodiments, the derivation module 406 may work with one or more components of the map engine 108 to traverse the map. Thus, knowing at least one root element (e.g., an object) associated with the litigation matter, further objects and/or the affected people and systems may be derived. For example, for a give OSCC, items of data classified by the OSCC will be stored in a particular information repository (e.g., file share or document management system). Typically, there is a steward (i.e., a person responsible for the information record keeping) for each repository. These stewards are affected people which need to be notified about the litigation matter. The process of traversing the map will be discussed in more detail in connection with FIG. 6.

The exemplary workflow module 408 automatically determines workflow based on the search results from the derivation module 406. In exemplary embodiments, the list of affected people and systems drives processes to preserve and produce data associated with the affected people and systems.

In exemplary embodiments, preservation workflow processes comprises sending legal hold notices to the affected people and planning and executing interviews with affected people. The legal hold notices will instruct the affected people not to destroy data related to the litigation matter. The interviews, in turn, may determine additional scope parameters to apply to the litigation matter. The interviews may also identify more affected people and systems, which may or may not be within the enterprise system 106. For example, a contractor may have been involved on the litigation matter.

Exemplary production workflow processes may comprise sending legal notices to produce the data or evidence. In some embodiments, the legal notices may be sent to the legal staff and instruct the legal staff on how and when to perform production. In alternative embodiments, the legal notices may be sent to one or more of the affected people with instructions on how and when to perform production.

The production workflow process may also comprise automatic generation of a collection workflow. The collection workflow provides plans and plan execution to drive the collection of data and evidence associated with the litigation matter. The collection plans target collection from the affected people and systems.

The notification module 410 is configured to provide the notices based on the workflow determined by the workflow module 408. For example, if the workflow module 408 determines that a steward of a repository needs to be notified not to destroy documents associated with a particular OSCC over a certain time period, the notification module 410 may generate a template containing this information (e.g., the OSCC, time period, and steward name and contact information) which the user 102 can use to send the notification to the steward. In other embodiments, the notification may be automatically sent without user 102 interaction.

The exemplary user interface module 412 is configured to allow the user 102 to utilize the litigation management engine 110 to derive a list of key people and/or systems. In some embodiments, the user interface module 412 provides a graphical user interface (GUI) which allows the user 102 to create the matter and provide the scope parameters for the derivation. In further embodiments, the user interface module 412 provides GUIs for showing results of the derivation. In some embodiments, the user interface module 412 may be optional.

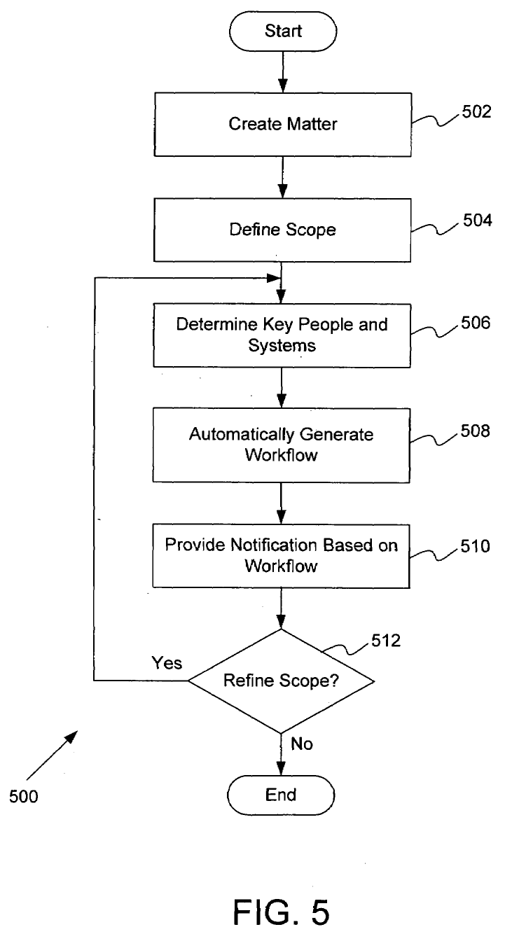

Referring now to FIG. 5, a flowchart 500 of a method for utilizing the enterprise map to determine affect people and systems is provided. In step 502, the user 102 creates a litigation matter. The litigation matter will identify the litigation and in some embodiments, the legal staff associated with the litigation matter. Additional information may be associated with the litigation matter.

In step 504, the scope for the derivation of a list of affected people and/or systems is defined. In exemplary embodiments, the user 102 provides initial scope parameters via a GUI. The scope parameters identify the root elements or objects in the map that are used as the starting point of the search. Scope parameters may comprise OSCC, organization, people, information type, or any other information that is related to the litigation matter.

Based on the scope parameters the derivation module determines the affected people and systems in step 506. In exemplary embodiments, the enterprise map is traversed to determine the affected people and systems based on relationships identified within the map. Thus, knowing at least one root element/parameter (e.g., an object) associated with the litigation matter, further elements/parameters and/or the affected people and systems may be derived. The process of determining the affected people and systems will be discussed in more detail in connection with FIG. 6.

Once the affected people and systems are identified, workflow is automatically generated in step 508. In exemplary embodiments, a workflow module 408 generates workflow for the user 102, legal staff, and/or affected people. Notifications based on the workflow may be provided in step 510 to the affect people. Other processes may also be performed based on the generated workflow. For example, interviews may be conducted with affected people in order to determine more, for example, more scope parameters which should be investigated.

In optional step 512, the scope for the derivation of a list of affected people and/or systems may be refined. In some embodiments, the user 102 may review the results and narrow the scope parameters or provide additional scope parameters. If the scope is refined, a new determination of key people and systems is performed in step 506. In an alternative embodiment, the scope may be refined after the determination of key people and systems (step 506) and before any workflow is generated (step 508).

Referring now to FIG. 6, a flowchart (step 506) of an exemplary method for deriving the affected people and systems is provided. In step 602, the derivation module 406, based on any information type scope parameters, determines all OSCC associated with the information type scope parameters. As previously discussed, OSCCs are classification codes that are based, in part, on information type. For example, if the user 102 is interested in documents that are associated with taxes, the corresponding OSCC with an information type of taxes is determined.

Based on any OSCCs either entered as scope parameters or derived in step 602, repositories associated with the OSCC are identified in step 604. Each repository is associated with a steward (i.e., a records manager for the repository. Therefore, in step 606, stewards are determined based on any entered repository scope parameters or based on the derived repositories from step 604. The stewards may be added to a list of affected people.

Based on any OSCCs either entered as scope parameters or derived in step 602, organizations identified by the OSCC are determined in step 608. As previously discussed, the OSCC is a classification code based, in part, on the organization.

Based on any organizations entered as scope parameters or derived in step 608, employees of organizations (step 610), repositories associated with the organizations (step 612), and stewards associated with the organization (step 614) are determined. The stewards may also be determined based on the repositories identified in step 612.

A list of determined affected people and systems is then compiled in step 616. The list will include, for example, the repositories (e.g., affected systems), stewards, administrators, and IT managers of those repositories, and employees/personnel of the affected organizations.

Referring now to FIG. 7A-FIG. 7C, screen shots of an exemplary GUI for providing scope parameters are shown. According to exemplary embodiments, previously entered scope parameters are shown in a scope display 702, while new scope parameters are entered via a resource chooser display 704. In FIG. 7A, scope parameters for information type are selected for entry in the resource chooser display 704. All information types associated with the enterprise 106 are available via an information section 706 of the resource chooser display 704. In the present embodiment, corporate information types are presented for selection. The user may select any of the information types by, for example, checking a box next to the information type of interest. Alternative embodiments may provide other mechanisms for entering information type scope parameters, such as for example, manually entering the information type or keywords associated with the information type.

FIG. 7B shows the same GUI as that of FIG. 7A, but with an organization section 710 selected in the resource chooser display 704. As shown, a list of organizations in the enterprise 106 is presented to the user 102 to select from. Additionally or alternatively, the user 102 may scroll through the list of organizations to select the scope parameters. The user may select any of the organizations by, for example, checking a box next to the organization of interest or by any other selection mechanism.

The user may also enter the organization name in an organization name field 712. If the enterprise spans more than one jurisdiction, a plurality of organizations may share the same name. Therefore, a country code field 714 may be provided to allow the user 102 to select the jurisdiction associated with the organization. By using these two fields 712 and 714, a list of organizations in the organization section may be narrowed.

FIG. 7C shows the same GUI now with a custodian section 720 selected. The custodian section 720 provides a list of repositories associated with the enterprise 106. In exemplary embodiments, the user 102 may narrow the list by providing a name in a custodian title field 722. The user may select any of the repositories by, for example, checking a box next to the repository of interest or by using any other selection mechanism.

As shown, previously selected repositories are shown in the scope display 702. The previously selected repositories include the deal server and documentum at the NYC Investment Bank and Zantaz.

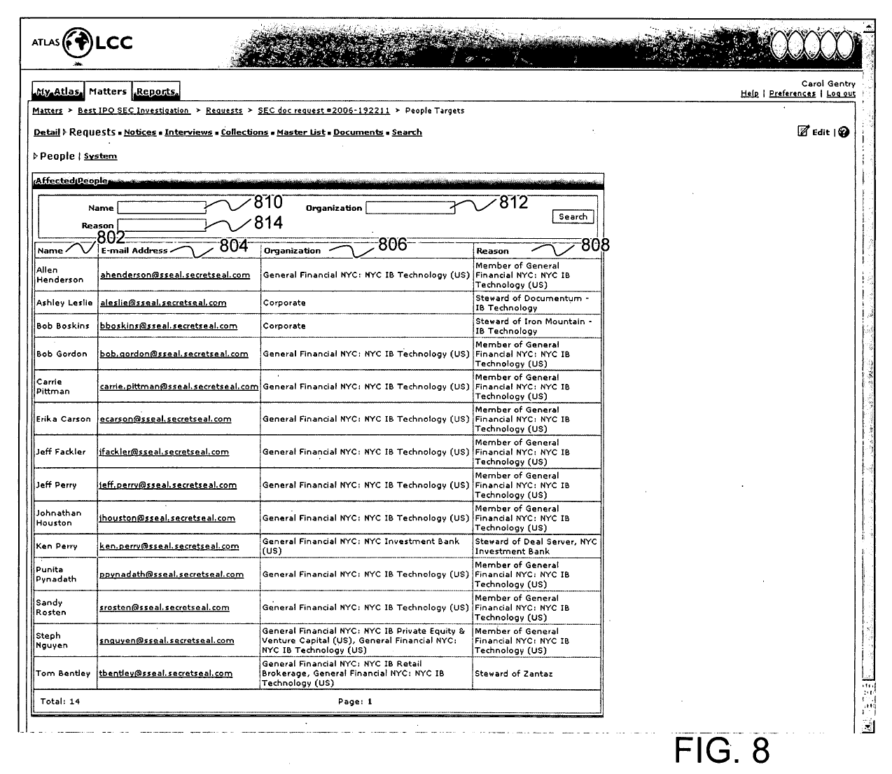

Referring now to FIG. 8, an exemplary screen shot of a GUI illustrating a derived list of affected people is shown. As shown, the derived list provides names 802, e-mail addresses 804 and organizations 806 of the affected people. The derived list also provides at least one reason 808 as to why the person was included in the derived list.

The user 102 may also narrow or sort the derived list by providing a name in a name field 810, an organization in an organization field 812, and/or a reason in a reason field 814.

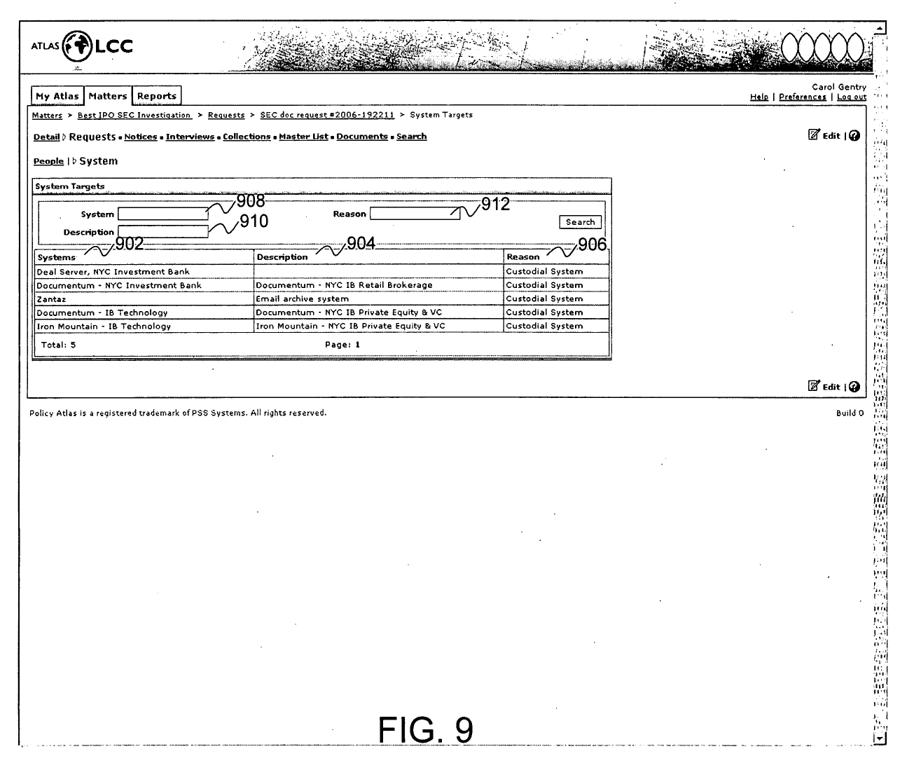

Referring now to FIG. 9, an exemplary screen shot of a GUI illustrating a derived list of affected systems is shown. The derived list provides a name of the system 902, a description of the system 904, and a reason 906 as to why the system is included in the derived list. In the present example, the systems are included because they are all affected repositories.

The user 102 may also narrow or sort the derived list by providing a system name in a system field 908, a description in a description field 910, and/or a reason in a reason field 912.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

1. A method for utilizing an enterprise map to determine affected entities via a computing device having a processor to execute instructions stored in memory, the method comprising:
executing instructions stored in memory by the processor to:
receive at least one scope parameter via the computing device, wherein the at least one scope parameter comprises one or more objects of the enterprise map, the one or more objects associated with a litigation matter, the at least one scope parameter identifying at least one root object in the enterprise map to be used as a starting point of a search to determine the affected entities associated with the litigation matter, the enterprise map providing relationships between the one or more objects which represent data comprising an enterprise;
utilize the at least one scope parameter and relationships identified in the enterprise map to automatically determine the affected entities via a traversal of the enterprise map, the affected entities comprising people or systems associated with the enterprise;
to compile a list of the affected entities; and
based on the automatic determination of the affected entities via the traversal of the enterprise map, notify one or more of the affected entities to preserve and produce information related to the litigation matter.

2. The method of claim 1, further comprising creating a litigation matter associated with the affected entities.

3. The method of claim 1 wherein utilizing the at least one scope parameter comprises determining at least one organizational specific classification code (OSCC) associated with an information type scope parameter, the at least one OSCC comprising an identifier of both an information type and an organization within a single classification code.

4. The method of claim 1 wherein utilizing the at least one scope parameter comprises determining repositories associated with the at least one organizational specific classification code (OSCC), the at least one OSCC comprising an identifier of both an information type and an organization within a single classification code.

5. The method of claim 1 wherein utilizing the at least one scope parameter comprises determining organizations associated with the at least one organizational specific classification code (OSCC), the at least one OSCC comprising an identifier of both an information type and an organization within a single classification code.

6. The method of claim 1 wherein utilizing the at least one scope parameter comprises determining employees associated with an organization scope parameter.

7. The method of claim 1 wherein utilizing the at least one scope parameter comprises determining repositories associated with an organization scope parameter.

8. The method of claim 1 wherein utilizing the at least one scope parameter comprises determining stewards associated with an organization scope parameter.

9. The method of claim 1 wherein utilizing the at least one scope parameter comprises determining at least one further scope parameter.

10. (canceled)

11. (canceled)

12. The method of claim 1 further comprising automatically generating workflow based on the list of affected entities.

13. The method of claim 12 further comprising providing the affected entities with notifications associated with the workflow.

14. A system for utilizing an enterprise map to determine affected entities, comprising:
a computing device having a memory and a processor, the memory configured to store data;
the processor configured to execute instructions stored in memory to: receive at least one scope parameter, wherein the at least one scope parameter comprises one or more objects of the enterprise map, the one or more objects associated with a litigation matter, the at least one scope parameter identifying at least one root object in the enterprise map to be used as a starting point of a search to determine the affected entities associated with the litigation matter, the enterprise map providing relationships between the one or more objects which represent data comprising an enterprise;
utilize the at least one scope parameter and relationships in the enterprise map to automatically determine the affected entities via a traversal of the enterprise map, the affected entities comprising people or systems associated with the enterprise;
compile a list of the affected entities; and
based on the automatic determination of the affected entities via the traversal of the enterprise map, notify one or more of the affected entities to preserve and produce information related to the litigation matter.

15. (canceled)

16. (canceled)

17. The system of claim 14, wherein the processor is further to execute instructions to automatically generate workflow based on results from the processor.

18. The system of claim 14, wherein the processor is further configured to execute instructions to provide notifications to the affected entities.

19. The system of claim 14, wherein the processor is further configured to execute instructions to set up the litigation matter for which the affected entities may be determined.

20. The system of claim 14 wherein the processor is further configured to execute instructions to utilize the at least one scope parameter to determine at least one further scope parameter.

21. A computer readable storage medium having a program embodied thereon, the program being executable by a processor to perform a method for utilizing an enterprise map to determine affected entities, the method comprising:
receiving at least one scope parameter, wherein the at least one scope parameter comprises one or more objects of the enterprise map, the one or more objects associated with a litigation matter, the at least one scope parameter identifying at least one root object in the enterprise map to be used as a starting point of a search to determine the affected entities associated with the litigation matter, the enterprise map providing relationships between the one or more objects which represent data comprising an enterprise;
utilizing the at least one scope parameter and relationships identified in the enterprise map to automatically determine the affected entities via a traversal of the enterprise map, the affected entities comprising people or systems associated with the enterprise;
compiling a list of the affected entities; and
based on the automatic determination of the affected entities via the traversal of the enterprise map, notifying one or more of the affected entities to preserve and produce information related to the litigation matter.
